(19) United States
(12) Patent Application Publication
(10) Pub. No.: US 2026/0189521 A1
(43) Pub. Date: Jul. 2, 2026

(54) EXTENDING PARTICIPATION PERIODS FOR MEETING ENVIRONMENTS

(71) Applicant: International Business Machines Corporation, Armonk, NY (US)

(72) Inventors: Ai Li Hao, Beijing (CN); Yin Xia, Beijing (CN); Nan Chen, Beijing (CN); Huai Ying Xia, Beijing (CN)

(21) Appl. No.: 19/008,468

(22) Filed: Jan. 2, 2025

(51) Int. Cl. H04L 51/02; G06F 11/07; G06F 40/30

(52) U.S. Cl. CPC H04L 51/02; G06F 11/0793; G06F 40/30

(57) ABSTRACT

A method, according to one approach, includes: receiving video and/or audio recordings captured during an initial meeting of an extended meeting session. Meeting records referenced during the initial meeting are also received. The extended meeting session includes the initial meeting and a supplemental submission period. The meeting records as well as the video and/or audio recordings are used to train an AI based model to generate contextual information associated with the initial meeting. Moreover, the trained AI based model is integrated into one or more conversational interfaces, and the trained AI based model as well as the integrated conversational interface(s) are provided to intended participants of the extended meeting session. Moreover, in response to receiving inputs from the intended participants during the supplemental submission period, the inputs are used to re-train the AI based model.

### BACKGROUND

The present invention relates to distributed communication systems, and more specifically, this invention relates to improving access to information discussed during a meeting.

Web conferencing is an umbrella term which includes various types of online audio and/or video collaborative services, including webinars, video calls, group calls using voice over Internet protocol, etc. Applications for web conferencing include meetings, training events, lectures, presentations shared between web-connected computers, etc. In general, web conferencing is made possible by Internet technologies which allow for communication to exist between different locations. Web conferencing thereby offers data streams of text-based messages, audio signals, video and/or still images, etc., to be shared simultaneously, across geographically dispersed locations.

Web conferencing has become a frequently used tool to facilitate virtual work meetings and other group environments, like online teaching. While it is beneficial for information to be exchanged between each location in a virtual meeting to emulate an in-person meeting, at least some intended participants may not be available while the virtual meeting takes place. It is often difficult to schedule a meeting (of any kind) during a time that is convenient for all intended participants, e.g., due to different time zones, unexpected events, conflicting schedules, etc.

### SUMMARY

A method, according to one approach, includes: receiving video and/or audio recordings captured during an initial meeting of an extended meeting session. Meeting records referenced during the initial meeting are also received. The extended meeting session includes the initial meeting and a supplemental submission period. The meeting records as well as the video and/or audio recordings are used to train an AI based model to generate contextual information associated with the initial meeting. Moreover, the trained AI based model is integrated into one or more conversational interfaces, and the trained AI based model as well as the integrated conversational interface(s) are provided to intended participants of the extended meeting session. Moreover, in response to receiving inputs from the intended participants during the supplemental submission period, the inputs are used to re-train the AI based model.

A computer program product, according to another approach, includes: one or more computer-readable storage media. The computer program product also includes program instructions that are stored on the one or more storage media to perform the foregoing method.

A computer system, according to yet another approach, includes: a processor set, and one or more computer-readable storage media. The computer system also includes program instructions that are stored on the one or more storage media to cause the processor set to perform the foregoing method.

Other aspects and implementations of the present invention will become apparent from the following detailed description, which, when taken in conjunction with the drawings, illustrate by way of example the principles of the invention.

### BRIEF DESCRIPTION OF THE DRAWINGS

FIG. 1 is a diagram of a computing environment, in accordance with one approach.

FIG. 2 is a representational view of a distributed system, in accordance with one approach.

FIG. 3A is a flowchart of a method, in accordance with one approach.

FIG. 3B is a flowchart of sub-processes for one of the operations in the method of FIG. 3A, in accordance with one approach.

### DETAILED DESCRIPTION

The following description is made for the purpose of illustrating the general principles of the present invention and is not meant to limit the inventive concepts claimed herein. Further, particular features described herein can be used in combination with other described features in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc.

It must also be noted that, as used in the specification and the appended claims, the singular forms “a,” “an” and “the” include plural referents unless otherwise specified. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The following description discloses several preferred approaches of systems, methods and computer program products for forming AI based models using information captured during an extended meeting session. These AI based models are preferably trained to generate contextual information associated with details that were discussed, presented, questioned, highlighted, ignored, etc., during the extended meeting session. Moreover, by integrating such trained AI based models with one or more different conversational interfaces, approaches herein provide users the ability to easily interact with the AI based models and contribute to the continued exchange of information between the intended participants of an extended meeting session. The AI based models may thereby be re-trained in response to receiving additional inputs from intended participants during a supplemental submission period (i.e., after an initial meeting has ended). This allows the AI based models to generate contextual information associated with details that were discussed, presented, questioned, highlighted, ignored, etc., during the initial meeting as well as during the supplemental submission period. This desirably allows for intended participants to contribute to the exchange of information conducted during the extended meeting session regardless of whether they are able to ultimately attend an initial meeting with other intended participants, e.g., as will be described in further detail below.

In one general approach, a method includes: receiving video and/or audio recordings captured during an initial meeting of an extended meeting session. Meeting records referenced during the initial meeting are also received. The extended meeting session includes the initial meeting and a supplemental submission period. The meeting records as well as the video and/or audio recordings are used to train an AI based model to generate contextual information associated with the initial meeting. Moreover, the trained AI based model is integrated into one or more conversational interfaces, and the trained AI based model as well as the integrated conversational interface(s) are provided to intended participants of the extended meeting session. Moreover, in response to receiving inputs from the intended participants during the supplemental submission period, the inputs are used to re-train the AI based model.

In another general approach, a computer program product includes: one or more computer-readable storage media. The computer program product also includes program instructions that are stored on the one or more storage media to perform the foregoing method.

In yet another general approach, a computer system includes: a processor set, and one or more computer-readable storage media. The computer system also includes program instructions that are stored on the one or more storage media to cause the processor set to perform the foregoing method.

Various aspects of the present disclosure are described by narrative text, flowcharts, block diagrams of computer systems and/or block diagrams of the machine logic included in computer program product (CPP) approaches. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product approach (“CPP approach” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a computer processor. Without limitation, the computer-readable storage medium may be an electronic storage medium, a magnetic storage medium, an optical storage medium, an electromagnetic storage medium, a semiconductor storage medium, a mechanical storage medium, or any suitable combination of the foregoing. Some known types of storage devices that include these mediums include: diskette, hard disk, random access memory (RAM), read-only memory (ROM), erasable programmable read-only memory (EPROM or Flash memory), static random access memory (SRAM), compact disc read-only memory (CD-ROM), digital versatile disk (DVD), memory stick, floppy disk, mechanically encoded device (such as punch cards or pits/lands formed in a major surface of a disc) or any suitable combination of the foregoing. A computer-readable storage medium, as that term is used in the present disclosure, is not to be construed as storage in the form of transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but this does not render the storage device as transitory because the data is not transitory while it is stored.

Computing environment 100 contains an example of an environment for the execution of at least some of the computer code involved in performing the inventive methods, such as improved meeting participation code at block 150 for forming AI based models that are able to generate contextual information associated with details that were discussed, presented, questioned, highlighted, ignored, etc., during an initial meeting. Moreover, by integrating such trained AI based models with one or more different conversational interfaces, approaches herein provide users the ability to easily interact with the AI based models and contribute to the continued exchange of information between the intended participants of an extended meeting session. The AI based models may thereby be re-trained in response to receiving additional inputs from intended participants during a supplemental submission period (i.e., after the initial meeting has ended). This allows the AI based models to generate contextual information associated with continued interactions by the intended participants of the meeting. This desirably allows for the intended participants to contribute to the exchange of information conducted during the extended meeting session regardless of whether they are able to ultimately attend an initial meeting with other intended participants, e.g., as will be described in further detail below.

In addition to block 150, computing environment 100 includes, for example, computer 101, wide area network (WAN) 102, end user device (EUD) 103, remote server 104, public cloud 105, and private cloud 106. In this approach, computer 101 includes processor set 110 (including processing circuitry 120 and cache 121), communication fabric 111, volatile memory 112, persistent storage 113 (including operating system 122 and block 150, as identified above), peripheral device set 114 (including user interface (UI) device set 123, storage 124, and Internet of Things (IoT) sensor set 125), and network module 115. Remote server 104 includes remote database 130. Public cloud 105 includes gateway 140, cloud orchestration module 141, host physical machine set 142, virtual machine set 143, and container set 144.

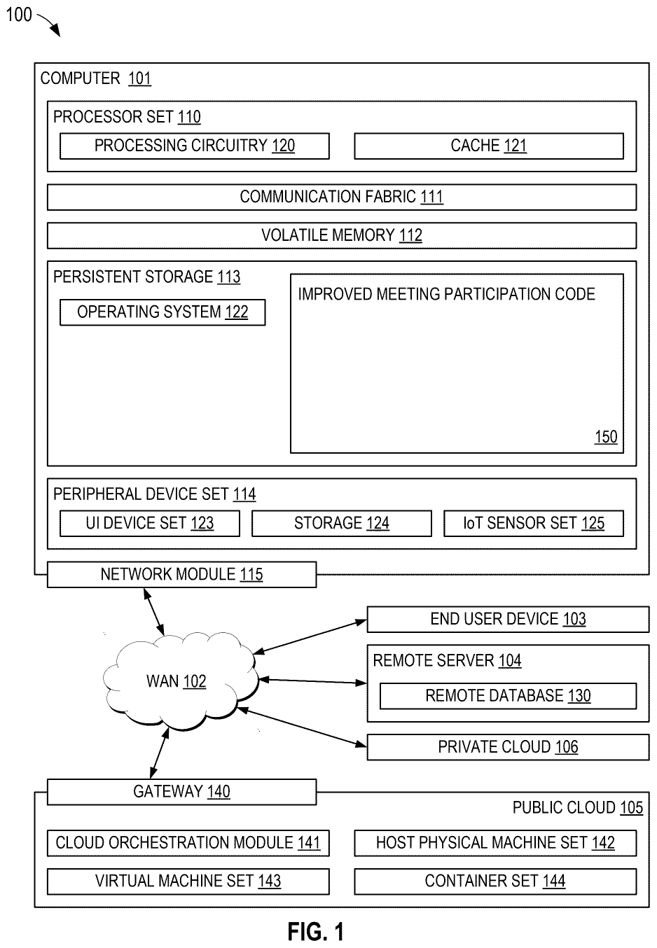

COMPUTER 101 may take the form of a desktop computer, laptop computer, tablet computer, smart phone, smart watch or other wearable computer, mainframe computer, quantum computer or any other form of computer or mobile device now known or to be developed in the future that is capable of running a program, accessing a network or querying a database, such as remote database 130. As is well understood in the art of computer technology, and depending upon the technology, performance of a computer-implemented method may be distributed among multiple computers and/or between multiple locations. On the other hand, in this presentation of computing environment 100, detailed discussion is focused on a single computer, specifically computer 101, to keep the presentation as simple as possible. Computer 101 may be located in a cloud, even though it is not shown in a cloud in FIG. 1. On the other hand, computer 101 is not required to be in a cloud except to any extent as may be affirmatively indicated.

PROCESSOR SET 110 includes one, or more, computer processors of any type now known or to be developed in the future. Processing circuitry 120 may be distributed over multiple packages, for example, multiple, coordinated integrated circuit chips. Processing circuitry 120 may implement multiple processor threads and/or multiple processor cores. Cache 121 is memory that is located in the processor chip package(s) and is typically used for data or code that should be available for rapid access by the threads or cores running on processor set 110. Cache memories are typically organized into multiple levels depending upon relative proximity to the processing circuitry. Alternatively, some, or all, of the cache for the processor set may be located “off chip.” In some computing environments, processor set 110 may be designed for working with qubits and performing quantum computing.

Computer readable program instructions are typically loaded onto computer 101 to cause a series of operational steps to be performed by processor set 110 of computer 101 and thereby effect a computer-implemented method, such that the instructions thus executed will instantiate the methods specified in flowcharts and/or narrative descriptions of computer-implemented methods included in this document (collectively referred to as “the inventive methods”). These computer readable program instructions are stored in various types of computer readable storage media, such as cache 121 and the other storage media discussed below. The program instructions, and associated data, are accessed by processor set 110 to control and direct performance of the inventive methods. In computing environment 100, at least some of the instructions for performing the inventive methods may be stored in block 150 in persistent storage 113.

COMMUNICATION FABRIC 111 is the signal conduction path that allows the various components of computer 101 to communicate with each other. Typically, this fabric is made of switches and electrically conductive paths, such as the switches and electrically conductive paths that make up buses, bridges, physical input/output ports and the like. Other types of signal communication paths may be used, such as fiber optic communication paths and/or wireless communication paths.

VOLATILE MEMORY 112 is any type of volatile memory now known or to be developed in the future. Examples include dynamic type random access memory (RAM) or static type RAM. Typically, volatile memory 112 is characterized by random access, but this is not required unless affirmatively indicated. In computer 101, the volatile memory 112 is located in a single package and is internal to computer 101, but, alternatively or additionally, the volatile memory may be distributed over multiple packages and/or located externally with respect to computer 101.

PERSISTENT STORAGE 113 is any form of non-volatile storage for computers that is now known or to be developed in the future. The non-volatility of this storage means that the stored data is maintained regardless of whether power is being supplied to computer 101 and/or directly to persistent storage 113. Persistent storage 113 may be a read only memory (ROM), but typically at least a portion of the persistent storage allows writing of data, deletion of data and re-writing of data. Some familiar forms of persistent storage include magnetic disks and solid state storage devices. Operating system 122 may take several forms, such as various known proprietary operating systems or open source Portable Operating System Interface-type operating systems that employ a kernel. The code included in block 150 typically includes at least some of the computer code involved in performing the inventive methods.

PERIPHERAL DEVICE SET 114 includes the set of peripheral devices of computer 101. Data communication connections between the peripheral devices and the other components of computer 101 may be implemented in various ways, such as Bluetooth connections, Near-Field Communication (NFC) connections, connections made by cables (such as universal serial bus (USB) type cables), insertion-type connections (for example, secure digital (SD) card), connections made through local area communication networks and even connections made through wide area networks such as the internet. In various approaches, UI device set 123 may include components such as a display screen, speaker, microphone, wearable devices (such as goggles and smart watches), keyboard, mouse, printer, touchpad, game controllers, and haptic devices. Storage 124 is external storage, such as an external hard drive, or insertable storage, such as an SD card. Storage 124 may be persistent and/or volatile. In some approaches, storage 124 may take the form of a quantum computing storage device for storing data in the form of qubits. In approaches where computer 101 is required to have a large amount of storage (for example, where computer 101 locally stores and manages a large database) then this storage may be provided by peripheral storage devices designed for storing very large amounts of data, such as a storage area network (SAN) that is shared by multiple, geographically distributed computers. IoT sensor set 125 is made up of sensors that can be used in Internet of Things applications. For example, one sensor may be a thermometer and another sensor may be a motion detector.

NETWORK MODULE 115 is the collection of computer software, hardware, and firmware that allows computer 101 to communicate with other computers through WAN 102. Network module 115 may include hardware, such as modems or Wi-Fi signal transceivers, software for packetizing and/or de-packetizing data for communication network transmission, and/or web browser software for communicating data over the internet. In some approaches, network control functions and network forwarding functions of network module 115 are performed on the same physical hardware device. In other approaches (for example, approaches that utilize software-defined networking (SDN)), the control functions and the forwarding functions of network module 115 are performed on physically separate devices, such that the control functions manage several different network hardware devices. Computer readable program instructions for performing the inventive methods can typically be downloaded to computer 101 from an external computer or external storage device through a network adapter card or network interface included in network module 115.

WAN 102 is any wide area network (for example, the internet) capable of communicating computer data over non-local distances by any technology for communicating computer data, now known or to be developed in the future. In some approaches, the WAN 102 may be replaced and/or supplemented by local area networks (LANs) designed to communicate data between devices located in a local area, such as a Wi-Fi network. The WAN and/or LANs typically include computer hardware such as copper transmission cables, optical transmission fibers, wireless transmission, routers, firewalls, switches, gateway computers and edge servers.

END USER DEVICE (EUD) 103 is any computer system that is used and controlled by an end user (for example, a customer of an enterprise that operates computer 101), and may take any of the forms discussed above in connection with computer 101. EUD 103 typically receives helpful and useful data from the operations of computer 101. For example, in a hypothetical case where computer 101 is designed to provide a recommendation to an end user, this recommendation would typically be communicated from network module 115 of computer 101 through WAN 102 to EUD 103. In this way, EUD 103 can display, or otherwise present, the recommendation to an end user. In some approaches, EUD 103 may be a client device, such as thin client, heavy client, mainframe computer, desktop computer and so on.

REMOTE SERVER 104 is any computer system that serves at least some data and/or functionality to computer 101. Remote server 104 may be controlled and used by the same entity that operates computer 101. Remote server 104 represents the machine(s) that collect and store helpful and useful data for use by other computers, such as computer 101. For example, in a hypothetical case where computer 101 is designed and programmed to provide a recommendation based on historical data, then this historical data may be provided to computer 101 from remote database 130 of remote server 104.

PUBLIC CLOUD 105 is any computer system available for use by multiple entities that provides on-demand availability of computer system resources and/or other computer capabilities, especially data storage (cloud storage) and computing power, without direct active management by the user. Cloud computing typically leverages sharing of resources to achieve coherence and economies of scale. The direct and active management of the computing resources of public cloud 105 is performed by the computer hardware and/or software of cloud orchestration module 141. The computing resources provided by public cloud 105 are typically implemented by virtual computing environments that run on various computers making up the computers of host physical machine set 142, which is the universe of physical computers in and/or available to public cloud 105. The virtual computing environments (VCEs) typically take the form of virtual machines from virtual machine set 143 and/or containers from container set 144. It is understood that these VCEs may be stored as images and may be transferred among and between the various physical machine hosts, either as images or after instantiation of the VCE. Cloud orchestration module 141 manages the transfer and storage of images, deploys new instantiations of VCEs and manages active instantiations of VCE deployments. Gateway 140 is the collection of computer software, hardware, and firmware that allows public cloud 105 to communicate through WAN 102.

Some further explanation of virtualized computing environments (VCEs) will now be provided. VCEs can be stored as “images.” A new active instance of the VCE can be instantiated from the image. Two familiar types of VCEs are virtual machines and containers. A container is a VCE that uses operating-system-level virtualization. This refers to an operating system feature in which the kernel allows the existence of multiple isolated user-space instances, called containers. These isolated user-space instances typically behave as real computers from the point of view of programs running in them. A computer program running on an ordinary operating system can utilize all resources of that computer, such as connected devices, files and folders, network shares, CPU power, and quantifiable hardware capabilities. However, programs running inside a container can only use the contents of the container and devices assigned to the container, a feature which is known as containerization.

PRIVATE CLOUD 106 is similar to public cloud 105, except that the computing resources are only available for use by a single enterprise. While private cloud 106 is depicted as being in communication with WAN 102, in other approaches a private cloud may be disconnected from the internet entirely and only accessible through a local/private network. A hybrid cloud is a composition of multiple clouds of different types (for example, private, community or public cloud types), often respectively implemented by different vendors. Each of the multiple clouds remains a separate and discrete entity, but the larger hybrid cloud architecture is bound together by standardized or proprietary technology that enables orchestration, management, and/or data/application portability between the multiple constituent clouds. In this approach, public cloud 105 and private cloud 106 are both part of a larger hybrid cloud.

CLOUD COMPUTING SERVICES AND/OR MICROSERVICES (not separately shown in FIG. 1): private and public clouds 106 are programmed and configured to deliver cloud computing services and/or microservices (unless otherwise indicated, the word “microservices” shall be interpreted as inclusive of larger “services” regardless of size). Cloud services are infrastructure, platforms, or software that are typically hosted by third-party providers and made available to users through the internet. Cloud services facilitate the flow of user data from front-end clients (for example, user-side servers, tablets, desktops, laptops), through the internet, to the provider's systems, and back. In some approaches, cloud services may be configured and orchestrated according to as “as a service” technology paradigm where something is being presented to an internal or external customer in the form of a cloud computing service. As-a-Service offerings typically provide endpoints with which various customers interface. These endpoints are typically based on an application programming interface (API) or set of application programming interfaces (APIs). One category of as-a-service offering is Platform as a Service (PaaS), where a service provider provisions, instantiates, runs, and manages a modular bundle of code that customers can use to instantiate a computing platform and one or more applications, without the complexity of building and maintaining the infrastructure typically associated with these things. Another category is Software as a Service (SaaS) where software is centrally hosted and allocated on a subscription basis. SaaS is also known as on-demand software, web-based software, or web-hosted software. Four technological sub-fields involved in cloud services are: deployment, integration, on demand, and virtual private networks.

In some aspects, a system according to various approaches may include a processor and logic integrated with and/or executable by the processor, the logic being configured to perform one or more of the process steps recited herein. The processor may be of any configuration as described herein, such as a discrete processor or a processing circuit that includes many components such as processing hardware, memory, I/O interfaces, etc. By integrated with, what is meant is that the processor has logic embedded therewith as hardware logic, such as an application specific integrated circuit (ASIC), a FPGA, etc. By executable by the processor, what is meant is that the logic is hardware logic; software logic such as firmware, part of an operating system, part of an application program; etc., or some combination of hardware and software logic that is accessible by the processor and configured to cause the processor to perform some functionality upon execution by the processor. Software logic may be stored on local and/or remote memory of any memory type, as known in the art. Any processor known in the art may be used, such as a software processor module and/or a hardware processor such as an ASIC, a FPGA, a central processing unit (CPU), an integrated circuit (IC), a graphics processing unit (GPU), etc.

Of course, this logic may be implemented as a method on any device and/or system or as a computer program product, according to various approaches.

As noted above, web conferencing is an umbrella term which includes various types of online audio and/or video collaborative services, including webinars, video calls, group calls using voice over Internet protocol, etc. Applications for web conferencing include meetings, training events, lectures, presentations shared between web-connected computers, etc. In general, web conferencing is made possible by Internet technologies which allow for communication to exist between different locations. Web conferencing thereby offers data streams of text-based messages, audio signals, video and/or still images, etc., to be shared simultaneously, across geographically dispersed locations.

Web conferencing has become a frequently used tool to facilitate virtual work meetings and other group environments, like online teaching. While it is beneficial for information to be exchanged between each location in a virtual meeting to emulate an in-person meeting, at least some intended participants may not be available while the virtual meeting takes place. It is often difficult to schedule a meeting (of any kind) during a time that is convenient for all intended participants, e.g., due to different time zones, unexpected events, conflicting schedules, etc. As a result, conventional products have limited access to information exchanged during such meetings, even in situations where virtual attendance is available to intended participants.

In sharp contrast to these conventional shortcomings, implementations herein are desirably able to expand and improve access to meeting information. For example, approaches train AI based models that are able to replicate a previous virtual meeting to intended participants that were unable to attend. Approaches herein also provide intended participants with opportunities to contribute to a meeting by supplementing the meeting information even after the previous virtual meeting has concluded. This effectively expands the window during which a virtual meeting may be experienced, making it easier for intended participants to experience and contribute to a virtual meeting. This also improves collaboration between intended participants of the virtual meeting, regardless of when they contribute to the virtual meeting (e.g., interact), e.g., as will be described in further detail below.

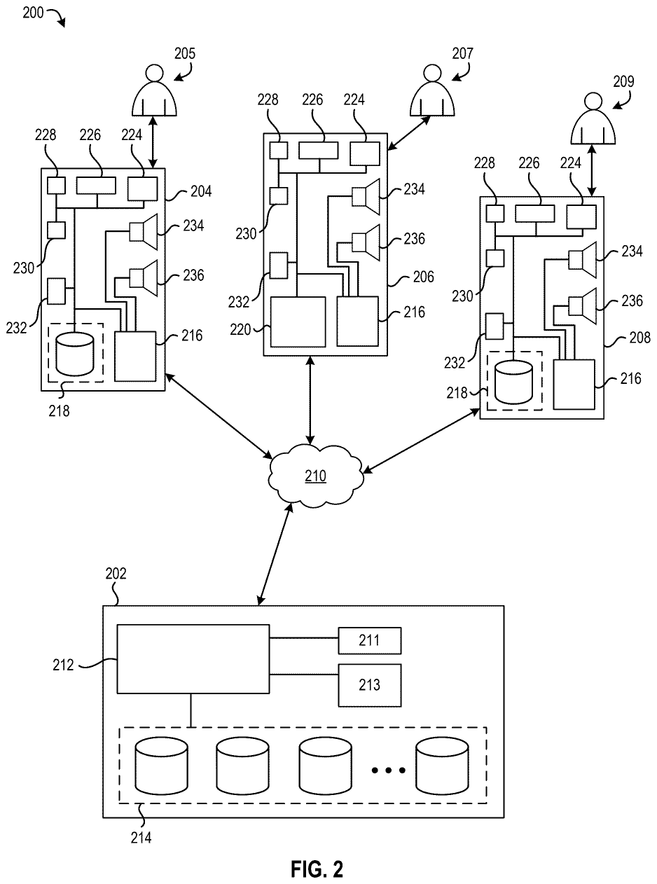

Looking now to FIG. 2, a system 200 having a distributed architecture is illustrated in accordance with one approach. As an option, the present system 200 may be implemented in conjunction with features from any other approach listed herein, such as those described with reference to the other FIGS., such as FIG. 1. However, such system 200 and others presented herein may be used in various applications and/or in permutations which may or may not be specifically described in the illustrative approaches or implementations listed herein. Further, the system 200 presented herein may be used in any desired environment. Thus FIG. 2 (and the other FIGS.) may be deemed to include any possible permutation.

As shown, the system 200 includes a central server 202 that is connected to electronic devices 204, 206, 208 accessible to the respective users 205, 207, 209. Each of these electronic devices 204, 206, 208 and respective users 205, 207, 209 may be separated from each other such that they are positioned in different geographical locations. For instance, the central server 202 and electronic devices 204, 206, 208 are connected to a network 210.

The network 210 may be of any type, e.g., depending on the desired approach. For instance, in some approaches the network 210 is a WAN, e.g., such as the Internet. However, an illustrative list of other network types which network 210 may implement includes, but is not limited to, a LAN, a PSTN, a SAN, an internal telephone network, etc. As a result, any desired information, data, commands, instructions, responses, requests, etc. may be sent between users 205, 207, 209 using the electronic devices 204, 206, 208 and/or central server 202, regardless of the amount of separation which exists therebetween, e.g., despite being positioned at different geographical locations.

However, it should also be noted that two or more of the electronic devices 204, 206, 208 and/or central server 202 may be connected differently depending on the approach. According to an example, which is in no way intended to limit the invention, two edge compute nodes may be located relatively close to each other and connected by a wired connection, e.g., a cable, a fiber-optic link, a wire, etc.; etc., or any other type of connection which would be apparent to one skilled in the art after reading the present description.

While each of the electronic devices 204, 206, 208 and central server 202 are shown as being connected to a same network 210, it should be noted that information may be sent between the locations differently depending on the implementation. According to an example, which is in no way intended to limit the invention, a shared (e.g., open) communication channel corresponding to a group video chat may be formed between each of the electronic devices 204, 206, 208. This shared communication channel may be formed by the processor 212 and/or AI module 213 in response to a scheduled meeting, receiving an impromptu request from a user, a predetermined condition being met, etc. The shared communication channel thereby allows the users 205, 207, 209 to exchange information (e.g., audio signals, video images, typed messages, etc.) freely between each other.

It should be noted that while approaches herein are described in the context of users accessing information presented during a virtual meeting (e.g., information that is exchanged between users), this is in no way intended to be limiting. For instance, while a “user” is described in approaches herein as an individual, the user may actually be an application, an organization, trained AI based model(s), etc. The use of “data” and “information” herein is in no way intended to be limiting either, and may include any desired type of details, e.g., such as inputs received from users, logical data storage locations, logical to physical tables, data write details, physical data storage locations, sensor readings, etc.

With continued reference to FIG. 2, the electronic devices 204, 206, 208 are shown as having a different configuration than the central server 202. For example, in some implementations the central server 202 includes a large (e.g., robust) processor 212 coupled to a cache 211, an AI module 213, and a data storage array 214 having a relatively high storage capacity. In some approaches, the processor 212 includes a channel management module that is able to establish, maintain, and end communication paths between the electronic devices 204, 206, 208 and/or one or more trained AI based models in the AI module 213. The central server 202 is thereby able to process and store a relatively large amount of data, as well as manage access to information exchanged between at least some participants of a virtual meeting. This allows the central server 202 to connect to, and manage, the exchange of information between multiple different devices 204, 206, 208 at respective user locations, e.g., as described in further detail below in method 300.

With continued reference to FIG. 2, the AI module 213 may include any desired number and/or type of AI based models, e.g., such as machine learning models, deep learning models, neural networks, etc. In preferred approaches, the AI module 213 may include one or more AI based models that have been formed using meeting records as well as video and/or audio recordings captured during an initial meeting of an extended meeting session. These AI based models may be trained to generate contextual information associated with details that were discussed, presented, questioned, highlighted, ignored, etc., during the initial meeting. The AI module 213 may further integrate such trained AI based models with one or more different conversational interfaces that allow for interactions with the AI based models to be more tailored for users. In some approaches, the AI module 213 may integrate the trained AI based models with one or more large language models (LLMs), language models, chatbots, generative models, etc., that are able to act as an intermediary that converts inputs provided by a user into rich data that is used as inputs to the trained AI based models, and converts outputs produced by the AI based models into details that are accessible to users.

It follows that the AI based models in AI module 213 may also be re-trained in response to receiving additional inputs. For instance, inputs from intended participants of the extended meeting session that are received during a supplemental submission period (i.e., after the initial meeting has ended, but still during the extended meeting session), may be used to re-train the AI based models. As a result, the AI based models are able to generate contextual information associated with details that were discussed, presented, questioned, highlighted, ignored, etc., during the initial meeting as well as during the supplemental submission period.

According to a non-limiting example, participants who were unable to attend the initial meeting can interact (e.g., chat) with the trained AI based models through the LLMs and/or chatbots provided (e.g., over an network connection) to acquire information associated with the initial meeting and extended meeting session as a whole, e.g., such as which topics have been discussed, a most emphasized (or significant) discussion, each of the intended participants' opinions, concerns raised, etc. Moreover, interacting with the intended participants after the initial meeting has ended allows for input to continue to be received, e.g., for various topics that were discussed during the initial meeting. This desirably allows for intended participants to contribute to the exchange of information conducted during the extended meeting session regardless of whether they are able to ultimately attend an initial meeting with other intended participants.

It follows that the AI module 213 may include one or more components that are configured to achieve the functionality mentioned above. For instance, the AI module 213 may include a summary component that is configured to summarize inputs received from various intended participants of a meeting. In some approaches, the summary component may be used to combine aspects (e.g., features) of the AI based models, combine outputs produced by the AI based models, merge similar inputs to avoid running the AI based models unnecessarily, etc. The AI module 213 may also include a notification component that is preferably configured to interact with the intended participants of the meeting. The notification component may send notifications to the intended participants that outline the current status of any inputs provided from the participants. For example, the notification component may indicate whether each received input will be used to re-train one or more of the AI based models. However, the AI module 213 may include any desired components, e.g., as would be appreciated by one skilled in the art after reading the present description.

The central server 202 may also store at least some information about the different electronic devices 204, 206, 208 and/or users 205, 207, 209. For instance, user defined authentication information (e.g., passwords), action-based information (e.g., edits to a presentation), application preferences, performance metrics, etc., may be collected from the users 205, 207, 209 while attending and/or experiencing a virtual meeting and stored in memory for future use. Additionally, at least some of the information that is collected from the users may be hashed and randomized before being stored in memory in some approaches. For instance, some approaches include encrypting and storing preferential selections, geographical location information, passwords, etc. In some approaches, at least some of this information can later be used to customize certain details of a virtual meeting, and/or the meeting information exchanged therein, that is accessed. For example, machine learning models may be trained using information exchanged (e.g., presented) between participants of a past virtual meeting. The machine learning models may thereby be used to generate a virtual environment that allows intended participants to experience and contribute to a virtual meeting even after an initial iteration of the meeting has occurred, e.g., as will be described in further detail below.

Looking now to the electronic devices 204, 206, 208, each are shown as including a processor 216 coupled to memory 218, 220. The memory implemented at each of the electronic devices 204, 206, 208 may be used to store data received from one or more sensors (not shown) in communication with the respective electronic devices, the users 205, 207, 209 themselves, the central server 202, different systems also connected to network 210, etc. It follows that different types of memory may be used. According to an example, which is in no way intended to limit the invention, electronic devices 204 and 208 may include hard disk drives as memory 218 while electronic device 206 includes a solid state memory module as memory 220.

The processor 216 is also connected to a display screen 224, a keyboard 226, a computer mouse 228, a microphone 230, and a camera 232. The processor 216 may thereby be configured to receive inputs from the keyboard 226 and computer mouse 228 as entered by the users 205, 207, 209. These inputs typically correspond to information presented on the display screen 224 while the entries were received. Moreover, the inputs received from the keyboard 226 and computer mouse 228 may impact the information shown on display screen 224, data stored in memory 218, 220, information collected from the microphone 230 and/or camera 232, status of an operating system being implemented by processor 216, etc.

Each of the electronic devices 204, 206, 208 are also shown as including a first speaker 234 and a second speaker 236. The speakers 234, 236 correspond to a different audio channel extending from processor 216. Accordingly, each of the speakers 234, 236 may be used to perform the same or different audio signals compared to each other.

While the electronic devices 204, 206, 208 are depicted as including similar components and/or design, it should again be noted that each of these electronic devices 204, 206, 208 may include any desired components which may be implemented in any desired configuration. In some instances, each user device (e.g., mobile phone, laptop computer, desktop computer, etc.) connected to a network may be configured differently to provide each location with a different functionality. According to an example, which is in no way intended to limit the invention, electronic devices 204 may include a cryptographic module (not shown) that allows the user 205 to produce encrypted data, while electronic devices 206 includes a data compression module (not shown) that allows for data to be compressed before being sent over the network 210 and/or stored in memory, thereby improving performance of the system by reducing network strain and/or compute overhead at the electronic device itself.

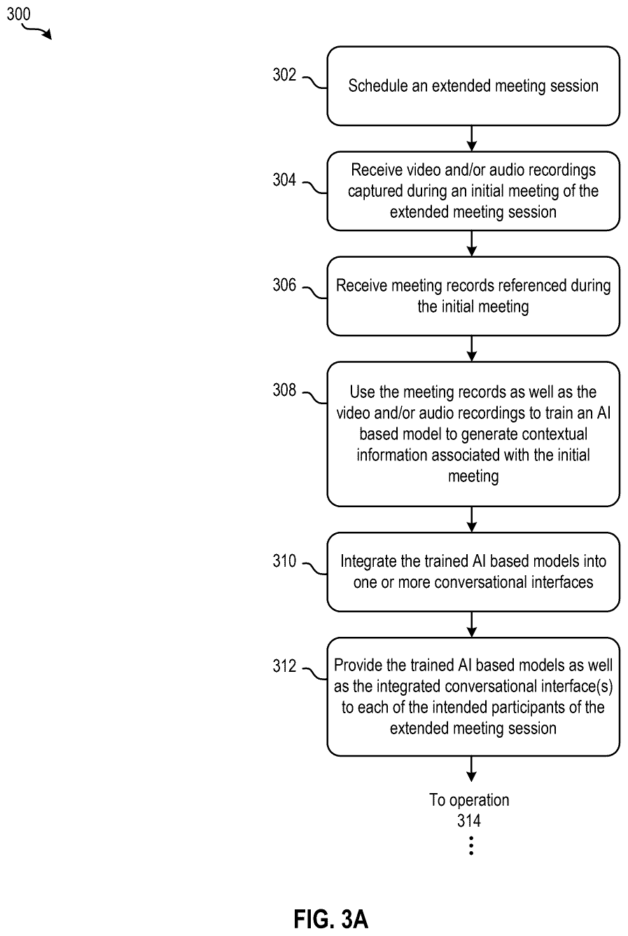

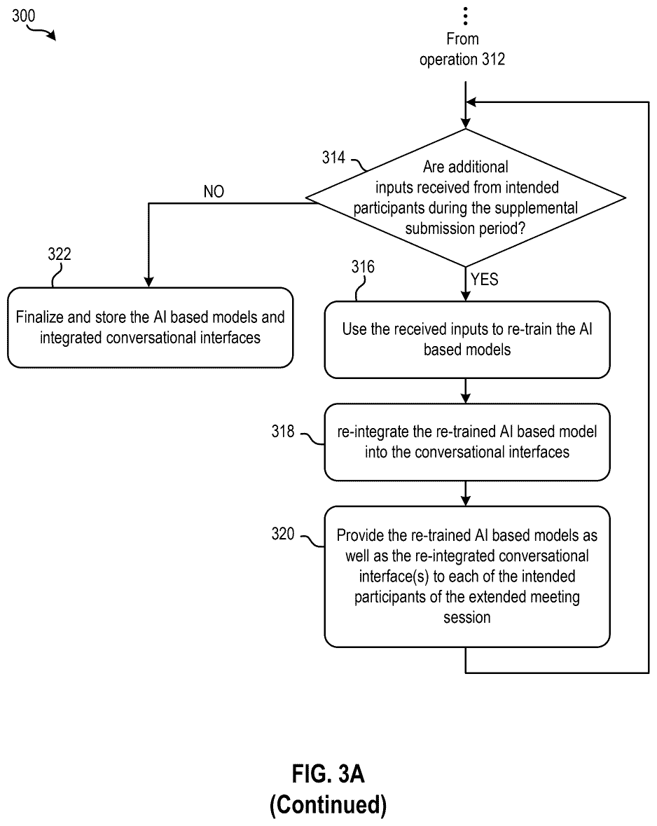

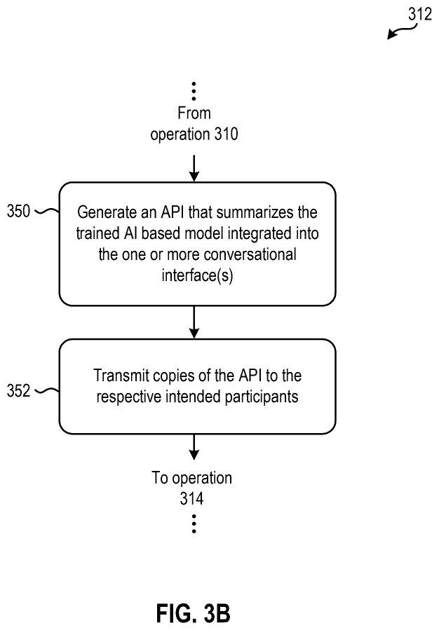

Looking now to FIG. 3A, a method 300 for forming AI based models using information captured during an initial meeting of an extended meeting session. These AI based models are preferably trained to generate contextual information associated with details that were discussed, presented, questioned, highlighted, ignored, etc., during the initial meeting. Moreover, by integrating such trained AI based models with one or more different conversational interfaces, method 300 provides users the ability to easily interact with the AI based models and contribute to the continued exchange of information between the intended participants. The AI based models may thereby be re-trained in response to receiving additional inputs from intended participants during the supplemental submission period (i.e., after the initial meeting has ended). This allows the AI based models to generate contextual information associated with details that were discussed, presented, questioned, highlighted, ignored, etc., during the initial meeting as well as during the supplemental submission period. This desirably allows for intended participants to contribute to the exchange of information conducted during the extended meeting session regardless of whether they are able to ultimately attend an initial meeting with other intended participants, e.g., as will be described in further detail below.

In some approaches, one or more of the operations in method 300 may be performed by, or in combination with (e.g., in response to sending one or more instructions to) AI based models that have undergone training to generate contextual information associated with details that were discussed, presented, questioned, highlighted, ignored, etc., during the initial meeting as well as during the supplemental submission period. Accordingly, the operations of method 300 may be performed continually in the background of an operating system without requesting input from a participant (e.g., human). Moreover, while certain results (e.g., warnings, reports, suggestions, etc.) may be generated and/or issued regarding results (e.g., responses) that are produced, it is again noted that the various operations of method 300 can be repeated in an iterative fashion to incorporate any desired number of inputs received from intended participants of an extended meeting session. Thus, method 300 may be performed in accordance with the present invention in any of the environments depicted in FIGS. 1-2, among others, in various approaches. Of course, more or less operations than those specifically described in FIG. 3A may be included in method 300, as would be understood by one of skill in the art upon reading the present descriptions.

Each of the steps of the method 300 may be performed by any suitable component of the operating environment. For example, in some approaches one or more of the operations in method 300 may be performed by a source hardened AI based model which is implemented in an AI based module (e.g., see AI module 213 of FIG. 2). However, the method 300 may be partially or entirely performed by a controller, a processor, a computer, etc., or some other device having one or more processors therein. Moreover, the terms computer, processor and controller may be used interchangeably with regards to any of the approaches herein, such components being considered equivalents in the many various permutations of the present invention.

For those approaches having a processor, the processor, e.g., processing circuit(s), chip(s), and/or module(s) implemented in hardware and/or software, and preferably having at least one hardware component may be utilized in any device to perform one or more steps of the method 300. Illustrative processors include, but are not limited to, a central processing unit (CPU), an application specific integrated circuit (ASIC), a field programmable gate array (FPGA), etc., combinations thereof, or any other suitable computing device known in the art.

Looking to FIG. 3A, operation 302 includes scheduling an extended meeting session. In other words, operation 302 includes determining a period of time on one or more specific days during which an extended meeting session will occur. The extended meeting session preferably includes an initial meeting that two or more of the intended participants are available to attend, as well as a supplemental submission period following the initial meeting during which the intended participants may contribute and otherwise interact (e.g., with an API) as if they were interacting with the remaining intended meeting members, e.g., as will be described in further detail below.

Operation 302 also includes coordinating with various logical and physical components to ensure intended participants of the extended meeting session are able to interact with each other (e.g., see and hear each other over a video call, interact with AI based models, etc.) during the scheduled period of time. Operation 302 may thereby involve sending one or more instructions to remote locations (e.g., the intended participants' locations) that cause changes to be made in preparation for the extended meeting session. For example, a calendar invite may be sent to each of the intended participants that includes a secure link to a virtual meeting room scheduled to open during an initial meeting of the extended meeting session.

In some approaches, operation 302 is performed in response to a user submitting a request to plan a meeting. For example, a user may interact with a graphical user interface that is integrated with an application running on their personal electronic device in order to submit an extended meeting session proposal. The proposal for the extended meeting session preferably includes start and stop times of an initial meeting as well as a supplemental submission period following the initial meeting. The initial meeting may have any desired length, e.g., such as 1, 2, 3, 4, 5, 7, 9, 10, 14, 15, 18, 20, 25, 30, 40, 50, 60, 75, 90, 120, 300, etc., minutes. Moreover, the supplemental submission period may have any desired length, e.g., such as 1, 2, 3, 4, 5, 7, 9, 10, 14, 15, 18, 20, 24, 36, 48, 64, 75, 90, 120, 300, etc., hours in length. While the supplemental submission period begins immediately in response to the initial meeting ending in some approaches, other approaches may implement a temporal gap between the conclusion of the initial meeting and the beginning of the supplemental submission period.

An extended meeting session proposal may be transmitted to a central compute location (e.g., see central server 202 in FIG. 2) for processing and/or implementation. In other approaches, one or more AI based models may be trained to manage and schedule extended meeting sessions based on available information. For example, the AI based models may evaluate calendars, emails, direct digital communication (e.g., texts, instant messages, direct messages, etc.), vocal communication, etc., that is exchanged between users in order to automatically determine whether extended meeting sessions should be scheduled. It follows that operation 302 may be automatically performed in response to receiving a output generated by one or more AI based models (e.g., without any user interaction). With respect to the present description, the “intended participants” refers to users that are permitted to attend (e.g., access) different aspects of an extended meeting session. In some approaches, the intended participants may be extracted from a received request to plan a meeting. In some approaches, the intended participants may be generated by an AI based model trained to evaluate previous groupings of participants and identify patterns that may be applied to future meetings sharing similar characteristics.

From operation 302, method 300 advances to operation 304. There, operation 304 includes receiving video and/or audio recordings captured during an initial meeting of the extended meeting session. In other words, information outlining what occurred during the initial meeting is captured in various formats and evaluated in further detail. The video and/or audio recordings may be received from each of the respective intended participants that attended the initial meeting. The amount and/or type of information captured during the initial meeting may thereby depend on the types of devices (e.g., sensors) available at each of the intended participants locations during the initial meeting. In other approaches, the video and/or audio recordings may actually be made (e.g., captured) at a central location from the video and/or audio signals being sent over a network between the intended participants attending the initial meeting, e.g., as would be appreciated by one skilled in the art after reading the present description. The video and/or audio recordings are preferably stored in memory in response to being received.

From operation 304, method 300 advances to operation 306. There, operation 306 includes receiving meeting records referenced during the initial meeting. In other words, operation 306 includes receiving any presentation materials (e.g., .PPT files, .PDF files, .JPG files, etc.), reference materials (e.g., cited websites, cited research papers, etc.), etc., or any other materials that were addressed (e.g., discussed, examined, alluded to, etc.) by the intended participants that attended the initial meeting. These meeting records provide additional context that may be used to further evaluate the information received in operation 304. For example, words spoken by the intended participants during the initial meeting may be identified and converted into a transcript having alphanumeric characters using one or more trained AI based models (e.g., LLMs). Words and phrases in the transcript may thereby be compared against information extracted from the received meeting records in order to gain a more acute understanding of how information was exchanged between intended participants during the initial meeting.

Accordingly, method 300 advances from operation 306 to operation 308. There, operation 308 includes using the meeting records as well as the video and/or audio recordings to train an AI based model to generate contextual information associated with the initial meeting. In other words, operation 308 includes using the information received in operations 304 and 306 to train one or more AI based models such that they are able to produce responses to various different inputs are associated with portions of the extended meeting session that have occurred.

In some approaches, the process of training the AI based models involves initially identifying key points in the meeting records and recordings. With respect to the present description, “key points” include details that summarize the contextual information exchanged between intended participants during the initial meeting and/or supplemental submission period of the extended meeting session. Key points may be identified in response to applying one or more predetermined processes, trained AI based models, evaluations, etc., to the meeting records and/or recordings. According to a non-limiting example, one or more common terms (e.g., words, phrases, etc.) may be identified from the meeting materials as key points. This identification may also be based at least in part on the intended participants, the date and/or time of the initial meeting and/or supplemental submission period, topics planned to be discussed during the extended meeting session, etc.

The identified key points are also extracted from the meeting records and recordings. The extracted key points may thereby be applied to the AI based models, causing the models to become trained in view of the input information. Thus, key points identified and extracted from the meeting records and recordings are used to train the AI based models to produce contextual information associated with the initial meeting. It follows that one or more of the AI based models include key point-based models that utilize key points as inputs while making determinations. However, any desired type of AI based model(s) may be implemented depending on the approach.

The meeting records and/or recordings may thereby be used to train an AI based model to generate answers to questions posed about what occurred during the initial meeting. This allows the AI based models to generate contextual information associated with details that were discussed, presented, questioned, highlighted, ignored, etc., during the initial meeting. This also desirably allows for intended participants to have access to information exchanged during the initial meeting, regardless of whether they are able to ultimately attend the initial meeting, e.g., as will be described in further detail below.

From operation 308, method 300 advances to operation 310. There, operation 310 includes integrating the trained AI based models into one or more conversational interfaces. In other words, the AI based models are merged with LLMs, chatbots, generative models, etc., that are configured to be placed between users and the AI based models themselves. For instance, the conversational interfaces are able to convert inputs provided by a user into rich data that can be used as inputs for the trained AI based models, and convert outputs produced by the AI based models into details that are accessible to users. The conversational interfaces are thereby able to work in combination with the trained AI based models to generate responses to queries received that pertain to the initial meeting. However, it should be noted that the conversational interfaces do not simply integrate general information (e.g., knowledge) from the LLMs, chatbots, generative models, etc. themselves. Again, the AI based models are merged with LLMs, chatbots, generative models, etc., such that they are configured to be placed between users and the AI based models themselves to facilitate information corresponding to the initial meeting.

With continued reference to FIG. 3A, method 300 advances from operation 310 to operation 312. There, operation 312 includes providing the trained AI based models as well as the integrated conversational interface(s) to each of the intended participants of the extended meeting session. In other words, operation 312 involves providing each of the intended participants with access to the trained AI based models and integrated conversational interfaces. In some approaches, individual copies of the trained AI based models and integrated conversational interfaces may be created for each of the intended participants and provided thereto. Each of the intended participants may thereby run the same trained AI based models and integrated conversational interfaces, generating different outcomes based on the inputs provided by the intended participants at their respective locations. In other approaches, access to a central copy of the trained AI based models and integrated conversational interfaces may be provided to each of the intended participants. The intended participants may thereby use the link to access at least one of the conversational interfaces, providing access over a network to the AI based models that are integrated therewith.

Providing each of the intended participants with access to the trained AI based models and integrated conversational interfaces allows for the intended participants to apply the trained AI based models in response to interacting with the integrated conversational interfaces. Users may interact with the integrated conversational interfaces differently depending on the type of interface. For example, some integrated conversational interfaces may be configured to process audio inputs received from users. Users may thereby submit requests to the conversational interfaces by audibly articulating their requests (e.g., near a microphone). In another example, some integrated conversational interfaces may be configured to process visual inputs received from users. Users may thereby submit requests to the conversational interfaces by converting their requests into text (e.g., alphanumeric characters) that is then scanned by a camera.

In some approaches, each of the intended participants are provided access to the trained AI based models and integrated conversational interfaces in response to the initial meeting ending. In other words, the trained AI based models may be released to the intended participants after the initial meeting has been completed, e.g., such that each of the participants are able to interact with the trained AI based models. This allows time for all of the information submitted during the initial meeting to be incorporated into the AI based models and/or conversational interfaces. However, other approaches may involve providing access to the AI based models as they are trained in real-time. In other words, access to the AI based models is maintained as they are continuously updated while the initial meeting is conducted, thereby expanding the information that is available over time.

Referring momentarily to FIG. 3B, exemplary sub-operations of providing each of the intended participants with access to the trained AI based models and integrated conversational interfaces are illustrated in accordance with one approach. It follows that one or more of these sub-operations may be used to perform operation 312 of FIG. 3A. However, it should be noted that the sub-operations of FIG. 3B are illustrated in accordance with one approach which is in no way intended to be limiting.

As shown, sub-operation 350 includes generating an API that summarizes the trained AI based model integrated into the one or more conversational interface(s). In other words, sub-operation 350 includes developing an interface that allows users to interact with the trained AI based model. This is preferably accomplished by combining (e.g., implementing) the one or more conversational interface(s) with the API. In other words, the API is preferably configured such that inputs submitted by users through the API are provided to the conversational interfaces, which in turn provide inputs to the trained AI based models. The API thereby serves as a channel tailored to interact with users and transfer received inputs to the AI based models for evaluation. Similarly, the API may direct outputs produced by the AI based models, and/or converted (e.g., translated) by the conversational interfaces, to the corresponding user(s), e.g., as would be appreciated by one skilled in the art after reading the present description.

The API preferably defines how other programs, LLMs, chatbots, etc., are able to communicate with the AI based models. In other words, the API outlines how various conversational interfaces can interact with the AI based models. The API may further be deployed at a central server, a cloud platform, a publicly accessible internet address, etc., such that it may be accessed as desired. Thus, in situations involving user queries that impact the functionality of the AI based models, API calls may be made to any endpoints that are exposed. Moreover, any corresponding information may be passed as inputs to the API. Responses may also be received after submitting the API call, and the responses may be incorporated into the overall outputs that are generated by the AI based models and integrated conversational interfaces. In some approaches, the information output by the AI based models may be made to align with the context and/or a format expected. Moreover, error handling mechanisms may be implemented in situations where API calls to the AI based models fail and/or returns an unexpected result.

From sub-operation 350, the flowchart advances to sub-operation 352. There, sub-operation 352 includes transmitting (e.g., providing) copies of the API to the respective intended participants. The API copies may be sent to the intended participants over one or more networks. Moreover, in response to receiving a copy of the API, each intended participant is preferably able to access (e.g., interact with) the conversational interface and integrated AI based models. Intended participants may thereby submit queries, ideas, potential answers to queries posed earlier in the extended meeting session, etc., that are evaluated and implemented by the AI based models. However, in some approaches, links that direct the intended participants to storage locations that actually hold the API(s) may be sent out. The intended participants may thereby access the link to interact with the API as desired without consuming storage capacity by storing a local copy of the API.

Referring back to FIG. 3A, in response to providing each of the intended participants with access to the trained AI based models and integrated conversational interfaces in operation 312, method 300 advances to operation 314. There, operation 314 includes determining whether any additional inputs are received from the intended participants during the supplemental submission period. In other words, operation 314 includes determining whether any of the intended participants submit additional information associated with the initial meeting before the extended meeting session ends.

In some approaches, the inputs that are received from intended participants are evaluated further before implementation. For instance, each received input may be inspected to determine whether it is actually supported by the conversational interfaces and/or the trained AI based models themselves. The inputs may be received from intended participants in different formats, sizes, languages, mediums, etc., some of which may not be compatible with the conversational interfaces and/or underlying trained AI based models. Operation 314 may thereby involve performing supplemental evaluations of the inputs and determining whether they are capable of reaching the intended (e.g., target) AI based model(s).

Inputs determined as being supported may be transferred directly to the corresponding conversational interfaces and/or AI based models, while inputs determined as not being supported may first undergo processing. For example, in response to determining an API call (input) received from an intended participant is not supported, the API call is at least temporarily held from being submitted to any of the AI based models. Rather, the non-supported API call may be submitted to one or more error handling mechanisms that are configured to make modifications thereto. The error handling mechanism may be able to compare the received input to formats and details that are supported by the target AI based models, and identify any discrepancies. The error handling mechanism may also be configured to evaluate inputs that cause the AI based models to produce one or more unexpected results. In other words, the error handling mechanism may be used to inspect and/or modify received inputs that cause one or more of the AI based models to produce results that are incorrect, in an unsupported format, do not match an expected value, etc.

The error handling mechanism preferably evaluates any API calls that are identified as being unsupported and/or or which produce one or more incorrect (e.g., unexpected) results, and makes modifications thereto. The modifications that are made to the inputs (e.g., API calls) are intended to cause the inputs to become compatible with the intended AI based models, and may vary depending on the situation. In some approaches, the error handling mechanism is configured to separate portions of the input which are supported from other portions which are not supported. In other words, the error handling mechanism may automatically remove (e.g., ignore) inputs identified as not being compatible with the AI based models, the conversational interfaces, API configurations, etc. Causing these errant inputs to not be processed ultimately improves performance of the AI models and integrated conversational interfaces. Moreover, the re-training that occurs in approaches herein (e.g., in response to receiving supported inputs from the intended participants) allows for the AI based models to adapt to changes over time and maintain efficient performance overall. However, it should be noted that inputs involving exceptional circumstances may not necessarily include errors to be removed.

In response to receiving one or more supported inputs from at least one of the intended participants during the supplemental submission period, method 300 advances from operation 314 to operation 316. There, operation 316 includes using the received inputs to re-train the AI based models. In other words, operation 316 includes updating the AI based models such that they are configured to generate contextual information associated with the initial meeting as well as any inputs that are received from intended participants during the supplemental submission period. The re-training performed in operation 316 may involve any of the approaches described above, e.g., with respect to the training performed in operation 308.

According to a non-limiting example, intended (e.g., verified) participants who were unable to attend the initial meeting can interact with the conversational interface in order for trained AI based models to produce contextual information pertaining to what occurred during the initial meeting (e.g., such as which topics have been discussed, what is the most important discussion, each participants opinion, ask concerned issues, etc.). These participants are also able to input current suggestions, responses, etc., for various topics that were discussed during the initial meeting. These inputs are thereby used to re-train the AI based models to produce contextual information pertaining to what occurred during the initial meeting, supplemented with any information received from intended participants during the supplemental submission period. This desirably allows for intended participants to contribute to the exchange of information regardless of whether they are able to ultimately attend an initial meeting with other intended participants.

With continued reference to FIG. 3A, method 300 advances from operation 316 to operation 318. There, operation 318 includes re-integrating the re-trained AI based model into the conversational interfaces. In other words, the re-trained AI based models are merged with the LLMs, chatbots, generative models, etc., that are configured to provide a conversational interface. The conversational interfaces are thereby able to work in combination with the re-trained AI based models to generate responses to queries received that pertain to the initial meeting as well as any information received during the supplemental submission period. Performing operation 318 may involve any of the approaches described above, e.g., with respect to performing operation 310.

Method 300 further advances from operation 318 to operation 320. There, operation 320 includes providing the re-trained AI based models as well as the re-integrated conversational interface(s) to each of the intended participants of the extended meeting session. In other words, operation 320 involves providing each of the intended participants with access to the re-trained AI based models and re-integrated conversational interfaces. Performing operation 320 may involve any of the approaches described above, e.g., with respect to performing operation 310.

Method 300 returns to operation 314 from operation 320, e.g., such that the supplemental submission period continue to be monitored. As noted above, operation 314 includes determining whether any additional inputs are received from the intended participants during the supplemental submission period. Operation 314 may thereby continue to be performed while the supplemental submission period is ongoing. Operations 316, 318, and 320 may also be repeated any desired number of times, e.g., in response to inputs received from intended participants during the extended meeting session, particularly during the supplemental submission period.

However, in response to determining that the supplemental submission period has ended, method 300 advances directly from operation 314 to operation 322. There, operation 322 includes finalizing and storing the AI based models and integrated conversational interfaces. In other words, operation 322 includes storing a version of the (re-)trained AI based models that most accurately reflect all information exchanged between the intended participants during the entire extended meeting session. Again, this is accomplished regardless of whether all intended participants are able to attend the initial meeting. Moreover, storing the trained AI based models and integrated conversational interfaces allows for them to be implemented as desired. For example, trained AI based models and/or integrated conversational interfaces may be accessed from storage and used to process one or more inputs received during subsequent extended meeting sessions.

Method 300 thereby includes innovative solutions that are able to assist intended participants of a group meeting to discuss and submit inputs (e.g., thoughts) that pertain to a group discussion. Again, by leveraging AI based models that are trained based on information already exchanged during a group meeting, and integrating such models with conversational interfaces, e.g., such as LLMs, chatbots, etc., subsequence discussion duration for the meeting is significantly extended from a specific time slot to a relatively long period of time, thereby increasing the chance of receiving inputs from each intended participant regardless of whether they were available at a same time as other intended participants.

It should be noted that additional security measures may also be implemented in combination with the approaches described above. For example, in addition to determining whether inputs are received from intended participants before allowing them to be processed, approaches herein may encrypt responses generated by the AI based models and/or conversational interfaces integrated therewith, before providing the responses to the intended participants.

In some approaches, the operations of method 300 may be performed by an AI model that is trained using a predetermined training set of data. For example, in some approaches, various of the operations noted above may be deployed in a trained state of a trained AI model. Training of the AI model, in some approaches, may be performed by applying a predetermined training data set to develop AI based models that are trained to generate contextual information associated with details that were discussed, presented, questioned, highlighted, ignored, etc., during different portions of an extended meeting session. The trained AI based models may further be integrated with one or more different conversational interfaces that allow for interactions with the AI based models to be more tailored for users. For example, the trained AI based models may be integrated with one or more LLMs, chatbots, generative models, etc., that are able to act as an intermediary that converts inputs provided by a user into rich data that is used as inputs to the trained AI based models, and converts outputs produced by the AI based models into details that are accessible to users.

Initial training of the AI based models can include reward feedback that may, in some approaches, be implemented using a subject matter expert (SME) that generally understands how received inputs pertain to information already discussed in an extended meeting session. However, to prevent costs associated with relying on manual actions of a SME, in another approach, reward feedback may be implemented using techniques for training a BERT model, as would become apparent to one skilled in the art after reading the present disclosure. Once a determination is made that the AI model achieves a redeemed threshold of accuracy of performing the operations described herein during this training, a decision that the model is trained and ready to deploy for performing techniques and/or operations of method 300 may be performed. In some further approaches, the AI model may be a neuromyotonic AI model that may improve performance of computer devices in an infrastructure associated with processing meeting interactions, because the neuromyotonic AI model may not need an SME and/or iteratively applied training with reward feedback in order to accurately perform operations described herein. Instead, the neuromyotonic AI model is configured to itself make determinations described in operations herein.

Moreover, weight values may be used by the AI reasoning model in some approaches to collect and analyze information and/or feedback potentially received from intended participants of the extended meeting session. Such an AI model ensures that each intended participant is able to access details already evaluated by other ones of the intended participants, and contribute to the meeting, where the scale of such analysis and determinations would not otherwise be feasible for a human to perform. This is because humans are not able to efficiently integrate current and continued submissions with previously discussed topics, and would otherwise incorporate processing delays and errors in the process of attempting to do so. Accordingly, management of operations described herein is not able to be achieved by human manual actions.

It will be clear that the various features of the foregoing systems and/or methodologies may be combined in any way, creating a plurality of combinations from the descriptions presented above.

It will be further appreciated that approaches of the present invention may be provided in the form of a service deployed on behalf of a customer to offer service on demand.

The descriptions of the various approaches of the present invention have been presented for purposes of illustration, but are not intended to be exhaustive or limited to the approaches disclosed. Many modifications and variations will be apparent to those of ordinary skill in the art without departing from the scope and spirit of the described approaches. The terminology used herein was chosen to best explain the principles of the approaches, the practical application or technical improvement over technologies found in the marketplace, or to enable others of ordinary skill in the art to understand the approaches disclosed herein.

What is claimed is:

1. A method comprising:
receiving video and/or audio recordings captured during an initial meeting of an extended meeting session, the extended meeting session including the initial meeting and a supplemental submission period;
receiving meeting records referenced during the initial meeting;
using the meeting records as well as the video and/or audio recordings to train an AI based model to generate contextual information associated with the initial meeting;
integrating the trained AI based model into one or more conversational interfaces;
providing the trained AI based model as well as the integrated conversational interface(s) to intended participants of the extended meeting session; and
in response to receiving inputs from the intended participants during the supplemental submission period, using the inputs to re-train the AI based model.

2. The method of claim 1, further comprising:
re-integrating the re-trained AI based model into the conversational interface(s); and
providing the re-trained AI based model as well as the re-integrated conversational interface(s) to the intended participants.

3. The method of claim 1, wherein the inputs from the intended participants are received during the supplemental submission period in response to the intended participants interacting with the trained AI based model as well as the one or more conversational interface(s) that are integrated therewith.

4. The method of claim 1, wherein using the meeting records as well as the video and/or audio recordings to train the AI based model includes:
extracting key points identified from the meeting records as well as the video and/or audio recordings; and
using the key points to train the AI based model.

5. The method of claim 1, wherein the providing the trained AI based model as well as the integrated one or more conversational interface(s) to the intended participants includes:
generating an application programming interface (API) that summarizes the trained AI based model integrated into the one or more conversational interface(s); and
transmitting copies of the API to the respective intended participants.

6. The method of claim 5, wherein the providing the trained AI based model as well as the integrated one or more conversational interface(s) to the intended participants further includes:
implementing one or more error handling mechanisms in response to an API call:
failing to reach the AI based model, and/or causing the AI based model to produce an unexpected result.

7. The method of claim 1, wherein the supplemental submission period begins in response to the initial meeting ending and extends 24 hours in length.

8. The method of claim 1, wherein the one or more conversational interface(s) include one or more: large language models and/or chatbots.

9. A computer program product comprising:
one or more computer-readable storage media; and
program instructions stored on the one or more storage media to perform operations comprising:
receiving video and/or audio recordings captured during an initial meeting of an extended meeting session, the extended meeting session including the initial meeting and a supplemental submission period;
receiving meeting records referenced during the initial meeting;
using the meeting records as well as the video and/or audio recordings to train an AI based model to generate contextual information associated with the initial meeting;
integrating the trained AI based model into one or more conversational interfaces;
providing the trained AI based model as well as the integrated conversational interface(s) to intended participants of the extended meeting session; and
in response to receiving inputs from the intended participants during the supplemental submission period, using the inputs to re-train the AI based model.

10. The computer program product of claim 9, wherein the operations further comprise:
re-integrating the re-trained AI based model into the conversational interface(s); and
providing the re-trained AI based model as well as the re-integrated conversational interface(s) to the intended participants.

11. The computer program product of claim 9, wherein the inputs from the intended participants are received during the supplemental submission period in response to the intended participants interacting with the trained AI based model as well as the one or more conversational interface(s) that are integrated therewith.

12. The computer program product of claim 9, wherein using the meeting records as well as the video and/or audio recordings to train the AI based model includes:
extracting key points identified from the meeting records as well as the video and/or audio recordings; and
using the key points to train the AI based model.

13. The computer program product of claim 9, wherein the providing the trained AI based model as well as the integrated one or more conversational interface(s) to the intended participants includes:
generating an application programming interface (API) that summarizes the trained AI based model integrated into the one or more conversational interface(s); and
transmitting copies of the API to the respective intended participants.

14. The computer program product of claim 13, wherein the providing the trained AI based model as well as the integrated one or more conversational interface(s) to the intended participants further includes:
implementing one or more error handling mechanisms in response to an API call: failing to reach the AI based model, and/or causing the AI based model to produce an unexpected result.

15. The computer program product of claim 9, wherein the supplemental submission period begins in response to the initial meeting ending and extends 24 hours in length.

16. The computer program product of claim 9, wherein the one or more conversational interface(s) include one or more: large language models and/or chatbots.

17. A computer system comprising:
a processor set;
one or more computer-readable storage media; and
program instructions stored on the one or more storage media to cause the processor set to perform operations comprising:
receiving video and/or audio recordings captured during an initial meeting of an extended meeting session, the extended meeting session including the initial meeting and a supplemental submission period;
receiving meeting records referenced during the initial meeting;
using the meeting records as well as the video and/or audio recordings to train an AI based model to generate contextual information associated with the initial meeting;
integrating the trained AI based model into one or more conversational interfaces;
providing the trained AI based model as well as the integrated conversational interface(s) to intended participants of the extended meeting session; and
in response to receiving inputs from the intended participants during the supplemental submission period, using the inputs to re-train the AI based model.

18. The system of claim 17, wherein the operations further comprise:
re-integrating the re-trained AI based model into the conversational interface(s); and
providing the re-trained AI based model as well as the re-integrated conversational interface(s) to the intended participants.

19. The system of claim 17, wherein the providing the trained AI based model as well as the integrated one or more conversational interface(s) to the intended participants includes:
generating an application programming interface (API) that summarizes the trained AI based model integrated into the one or more conversational interface(s);
transmitting copies of the API to the respective intended participants; and
implementing one or more error handling mechanisms in response to an API call: failing to reach the AI based model, and/or causing the AI based model to produce an unexpected result.

20. The system of claim 17, wherein the supplemental submission period begins in response to the initial meeting ending and extends 24 hours in length, wherein the one or more conversational interface(s) include one or more: large language models and/or chatbots.
